(19) United States
(12) Patent Application Publication
(10) Pub. No.: US 2005/0255778 A1
(43) Pub. Date: Nov. 17, 2005

(54) Fiber non-woven fabric

(76) Inventors: Takashi Okai, Kagawa (JP); Tomoaki Kimura, Osaka (JP); Toyoaki Kurihara, Ibaraki (JP); Kenichi Hamada, Ibaraki (JP); Akiko Ide, Hyogo (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/512,840

(22) PCT Filed: May 9, 2003
(86) PCT No.: PCT/JP03/05832

§ 371 Date: Oct. 28, 2004

(30) Foreign Application Priority Data
May 14, 2002 (JP) 2002-137891

(51) Int. Cl. B32B 27/02; D04H 1/00; D04H 5/00; D04H 1/56; B32B 27/12

(52) U.S. Cl. 442/400; 442/327; 442/333; 442/334; 428/299.7

(57) ABSTRACT

The invention provides a nonwoven fabric comprising fiber primarily formed of a (meth)acrylic-based block copolymer, wherein the (meth)acrylic-based block copolymer is a specific tri-block copolymer. The invention can provide a nonwoven fabric with excellent light resistance, weather resistance, durability, flexibility and stretchability.

### TECHNICAL FIELD

The present invention relates to a nonwoven fabric and, more particularly, to a nonwoven fabric which is constituted by fiber primarily formed of a (meth)acrylic-based block copolymer having a specific structure and which exhibits excellent light resistance, weather resistance, flexibility, and stretchability.

As used herein, the term “(meth)acrylic” refers collectively to “methacrylic” and “acrylic”.

### BACKGROUND ART

Conventionally, a variety of synthetic resins have been employed as raw materials for producing nonwoven fabric products. Among such products, a stretchable nonwoven fabric is known to be produced from a thermoplastic elastomer resin serving as a raw material. For example, Japanese Patent Application Laid-Open (kokai) No. 59-223347 discloses a polyurethane meltblown nonwoven fabric, and Japanese Patent Application Laid-Open (kokai) No. 62-84143 discloses a meltblown nonwoven fabric composed of a styrenic elastomer.

Although these thermoplastic elastomer nonwoven fabric products have excellent stretchability, light resistance and weather resistance thereof are unsatisfactory. Therefore, when these nonwoven fabric products are used as industrial materials such as agricultural materials, civil engineering materials, and filter materials, which are often used outdoors, light resistance and weather resistance must be improved.

In a conventionally employed approach for improving weather resistance, additives such as carbon black, an anti-oxidant, a UV-absorber, and a light-stabilizer are incorporated into nonwoven fabric. However, even when this conventional approach (i.e., addition of a weather resistant agent) is employed, obtained weather resistance is still unsatisfactory for use in an application requiring extremely high weather resistance. In particular, since the aforementioned stretchable nonwoven-fabric products made of polyurethane elastomer or styrenic elastomer are produced from a resin raw material having poor weather resistance, a weather resistant agent must be added in a large amount (about some %) so as to enhance weather resistance, which has remained a problem to be solved.

In addition, the additive-based approach improves light resistance and weather resistance only at an initial stage, and light resistance and weather resistance often become unsatisfactory after long-term use. The aforementioned additives are usually used in the form of-mixture with raw material. This raises the problems that the additives are exuded on the surface of the fiber filaments of nonwoven fabric during outdoor use, that the additives are released from the nonwoven fabric to contaminate the environment, and that flexibility of the nonwoven fabric is impaired.

According to another known means for improving weather resistance, a film sheet imparted with weather resistance is laminated on nonwoven fabric, thereby forming a composite product. However, the film sheet has poor dynamic characteristics and is easily broken, resulting in considerable decrease in water permeability and flexibility, which is also a problem to be solved.

The present invention has been made in order to solve the aforementioned problems. Thus, an object of the present invention is to provide a nonwoven fabric exhibiting excellent light resistance and weather resistance for a long period of time as well as having satisfactory flexibility and stretchability.

### DISCLOSURE OF THE INVENTION

The present inventors have conducted extensive studies in order to solve the aforementioned problems, and have found that a nonwoven fabric which is constituted by fiber primarily formed of a (meth)acrylic-based block copolymer having a specific structure attains excellent light resistance, weather resistance, flexibility, and stretchability. The present invention has been accomplished on the basis of this finding.

Accordingly, the present invention is directed to a nonwoven fabric comprising fiber primarily formed of a (meth)acrylic-based block copolymer, characterized in that the (meth)acrylic-based block copolymer satisfies the following (a) to (c):
(a) the (meth)acrylic-based block copolymer has a structure represented by the following formula (I):
   A1-B-A2 (I)
   (wherein A1 and A2, which may be identical to or different from each other, each represent a polymer block formed from a methacrylic ester, an acrylic ester, or an aromatic vinyl compound; B represents a polymer block formed from a methacrylic ester or an acrylic ester; and B is immiscible with A1 and A2 and has a glass transition temperature of 20° C. or lower);
(b) the (meth)acrylic-based block copolymer has a number average molecular weight of 8,000 to 700,000; and
(c) the (meth)acrylic-based block copolymer has a total polymer block A content of 20 to 45 mass % based on the entire mass of the block copolymer.

### BEST MODES FOR CARRYING OUT THE INVENTION

The present invention will next be described in detail.

The (meth)acrylic-based block copolymer forming the nonwoven fabric of the present invention is characterized in that the block copolymer contains a structure represented by the following formula (I):
A1-B-A2 (I)
(wherein A1 and A2, which may be identical to or different from each other, each represent a polymer block formed from a methacrylic ester, an acrylic ester, or an aromatic vinyl compound; B represents a polymer block formed from a methacrylic ester or an acrylic ester; and B is immiscible with A1 and A2 and has a glass transition temperature of 20° C. or lower).

As mentioned above, in the (meth)acrylic-based block copolymer, polymer block B is linked between polymer blocks A1 and A2, forming the block structure represented by the aforementioned formula (I). No particular limitation is imposed on the number of respective polymer blocks. For example, the block copolymer may be a tetra-block copolymer in which two polymer blocks A and two polymer blocks B are linked, or may contain polymer block A linked with polymer block B or one or more polymer blocks other than polymer blocks A and B. No particular limitation is imposed on the linkage manner of respective polymer blocks of the block copolymer, and any linkage type such as linear, poly-branched, or star-like may be employed.

Among the block copolymers, a block copolymer of tri-block type provides more excellent light resistance, weather resistance, and flexibility. The tri-block copolymer is particularly preferred, since excellent handling characteristics are advantageously obtained by virtue of high melt flowability and low surface stickiness.

Each of the polymer blocks A1 and A2, forming the (meth)acrylic-based block copolymer employed in the present invention, is a polymer block produced through polymerization of a methacrylic ester, an acrylic ester, or an aromatic vinyl compound.

Examples of the (meth)acrylic ester, serving as a monomer for forming the polymer block A1 or A2, include an ester of (meth)acrylic acid and a monohydric alcohol (C₁ to C₁₈, saturated or unsaturated, and linear, alicyclic, or heterocyclic). Specific examples include methyl methacrylate, ethyl methacrylate, propyl methacrylate, isopropyl methacrylate, n-butyl methacrylate, t-butyl methacrylate, cyclohexyl methacrylate, 2-ethylhexyl methacrylate, dodecyl methacrylate, glycidyl methacrylate, isobornyl methacrylate, allyl methacrylate, methoxyethyl methacrylate, methyl acrylate, ethyl acrylate, propyl acrylate, isopropyl acrylate, n-butyl acrylate, t-butyl acrylate, cyclohexyl acrylate, 2-ethylhexyl acrylate, dodecyl acrylate, glycidyl acrylate, isobornyl acrylate, allyl acrylate, and methoxyethyl acrylate. These monomers may be used singly or in combination of two or more species.

Specific examples of the aromatic vinyl compound, serving as a monomer for forming the polymer block A1 or A2, include styrene, α-methylstyrene, o-methylstyrene, m-methylstyrene, p-methylstyrene, vinyltoluene, 2,4-dimethylstyrene, vinylnaphthalene, and vinylanthracene. These monomers may be used singly or in combination of two or more species.

Among these monomers, a methacrylic ester, which is an ester of methacrylic acid and a C₁ to C₁₂ monohydric alcohol, is preferred as the monomer for forming polymer block A1 or A2, since excellent light resistance and weather resistance are obtained. Notably, the polymer blocks A1 and A2 may be identical to or different from each other.

In order to extend the employable temperature range for nonwoven fabric to higher temperature, at least one of the monomers for forming the polymer blocks A1 and A2 preferably has a glass transition temperature higher than 25° C.

From the aforementioned viewpoints, examples of particularly preferred monomers for forming the polymer blocks A1 or A2 include methyl methacrylate, ethyl methacrylate, propyl methacrylate, isopropyl methacrylate, t-butyl methacrylate, cyclohexyl methacrylate, glycidyl methacrylate, and isobornyl methacrylate. Of these, methyl methacrylate and isobornyl methacrylate are most preferred. These monomers may be used singly or in combination of two or more species.

The polymer block B, forming the (meth)acrylic-based block copolymer employed in the present invention, is a polymer block produced through polymerization of a methacrylic ester or an acrylic ester, and is immiscible with polymer blocks A1 and A2, which is a key characteristic.

By virtue of the aforementioned structure, the polymer blocks forming the block copolymer assume a micro-phase separation structure, which imparts elastomer-like characteristics to the block copolymer. Thus, when the nonwoven fabric is produced from the block copolymer, excellent flexibility and stretchability are provided.

Whether or not any two species of polymer blocks contained in the block copolymer are mutually miscible may be evaluated on the basis of, for example, glass transition temperature of the block copolymer as measured by means of a DSC (differential scanning calorimeter) or Tα (α dispersion temperature), which is a peak temperature in relation to tangent loss (tanδ) as measured through dynamic viscoelasticity measurement.

Specifically, in the block copolymer, when any two species of polymer blocks exhibit glass transition temperature values or Tα values which are identical to each other, a mutually miscible state of these two polymer blocks is identified, whereas when any two species of polymer blocks exhibit glass transition temperature values or Tα values which are different from each other, a mutually immiscible state of these two polymer blocks is identified.

In order to impart flexibility to the nonwoven fabric of the present invention, the polymer block B preferably has a glass transition temperature of 20° C. or lower, more preferably 10° C. or lower.

Examples of the monomer which forms the polymer block B and satisfies the aforementioned conditions include an ester of (meth)acrylic acid and a C₁ to C₁₆ monohydric alcohol. Specific examples include n-butyl methacrylate, 2-ethylhexyl methacrylate, dodecyl methacrylate, methoxyethyl methacrylate, methyl acrylate, ethyl acrylate, propyl acrylate, isopropyl acrylate, n-butyl acrylate, 2-ethylhexyl acrylate, dodecyl acrylate, and methoxyethyl acrylate.

In order to further enhance flexibility and stretchability of the nonwoven fabric of the present invention, the monomer for forming the polymer block B is preferably an acrylic ester; e.g., ester with a C₁ to C₈ monohydric alcohol (saturated, linear). Specific examples include methyl acrylate, ethyl acrylate, propyl acrylate, isopropyl acrylate, n-butyl acrylate, 2-ethylhexyl acrylate, dodecyl acrylate, and methoxyethyl acrylate. Of these, ethyl acrylate, propyl acrylate, isopropyl acrylate, n-butyl acrylate, and 2-ethylhexyl acrylate are particularly preferred. These monomers may be used singly (homopolymer) or in combination (copolymer).

The polymer blocks A1, A2, and B employed in the (meth)acrylic-based block copolymer of the present invention may further copolymerized with other monomers in accordance with needs, so long as the characteristics of each polymer block are not impaired. No particular limitation is imposed on the copolymerizable monomer, and examples include methacrylic acid, acrylic acid, N,N-dimethylacrylamide, N,N-diethylacrylamide, N-isopropylacrylamide, butadiene, isoprene, styrene, acrylonitrle, methacrolein, and acrolein.

From the viewpoint of fiber formability during fabrication of nonwoven fabric and dynamic characteristics of the fabricated nonwoven fabric, the (meth)acrylic-based block copolymer employed in the present invention has a number average molecular weight of 8,000 to 700,000, preferably 20,000 to 300,000, more preferably 30,000 to 200,000. When the number average molecular weight of the (meth)acrylic-based block copolymer is less than 8,000, phase separation of the polymer blocks A1 and A2 from the polymer block B is incomplete, thereby impairing characteristics such as tensile strength and heating resistance, whereas when the number average molecular weight is in excess of 700,000, melt viscosity of the resin increases, thereby impairing fiber formability.

The polymer block A (polymer blocks A1 and A2) content of the (meth)acrylic-based block copolymer employed in the present invention is 20 to 45 mass % with respect to the mass of the copolymer, preferably 22 to 40 mass %, more preferably 23 to 37 mass %. When the polymer block B content is excessively large, the produced nonwoven fabric tends to have a more sticky surface, and processing and handling the nonwoven fabric may be difficult. When the polymer block A content is in excess of 45 mass %, the produced nonwoven fabric has impaired flexibility with stiff feeling.

In the present invention, the block A content and the block B content can be determined through an analysis mean such as NMR (nuclear magnetic resonance spectrum).

From the viewpoint of fiber formability during fabrication of nonwoven fabric and dynamic characteristics of the fabricated nonwoven fabric, the (meth)acrylic-based block copolymer employed in the present invention has an MFR (melt flow rate, measured at 190° C. under a load of 21.18 N) of 0.5 to 150 g/10 min, preferably 1 to 100 g/10 min, and a durometer hardness (type A) of 30 to 100, preferably 35 to 90.

No particular limitation is imposed on the method for producing the (meth)acrylic-based block copolymer, and any method in accordance with a known technique may be employed. For example, a method in which monomers for forming blocks are living-polymerized is generally employed. Examples of such living polymerization techniques include anion polymerization by use of an organic alkali metal compound serving as a polymerization initiator and in the presence of a mineral acid salt such as an alkali metal salt or an alkaline earth metal salt (Japanese Patent Publication No. 7-25859); anion polymerization by use of an organic alkali metal compound serving as a polymerization initiator and in the presence of an organic aluminum compound (Japanese Patent Application Laid-Open (kokai) No. 11-335432); polymerization by use of an organic rare earth metal complex serving as a polymerization initiator (Japanese Patent Application Laid-Open (kokai) No. 6-93060); and radical polymerization by use of an α-halo ester compound serving as a polymerization initiator and in the presence of a copper compound (Macromol. Chem. Phys. 201, 1108-1114 (2000)). Alternatively, there may be employed a method in which monomers for forming blocks are polymerized by use of a multivalent radical polymerization initiator or a multivalent chain-transfer agent, to thereby produce a mixture containing the block copolymer of the present invention.

Among these methods, the anion polymerization by use of an organic alkali metal compound serving as a polymerization initiator and in the presence of an organic aluminum compound is particularly recommended, since the method can produce a high-purity block copolymer, allows easy control of molecular weight and compositional proportions, and is economically advantageous.

The nonwoven fabric of the present invention will next be described.

The nonwoven fabric of the present invention is comprised of fiber primarily formed of the aforementioned (meth)acrylic-based block copolymer, and may further contain another fiber, so long as the effects of the present invention are not impaired. Preferably, the nonwoven fabric of the present invention is composed of 100 mass % of the (meth)acrylic-based block copolymer.

Generally, nonwoven fabric is produced through a known method such as a dry laying (e.g., a carding or an airlaying), a wetlaying, or a direct spinning (e.g., a spunlaying or a meltblowing). So long as the object of the present invention can be attained, the nonwoven fabric of the present invention may be produced through any of the aforementioned methods. When fiber filaments are produced through melt-spinning of an elastomer resin, some specific conditions must be generally employed. In the present invention, however, the meltblowing is particularly preferred, since the resin for forming the nonwoven fabric has low melt viscosity and excellent melt flowability. Basic apparatuses and a detailed method in relation to spinning through the meltblowing are disclosed in, for example, Industrial and Engineering Chemistry (Vol. 48, No. 8, p. 1,342 to 1,346, (1956)). The nonwoven fabric can be produced through the method.

Specifically, a resin composition melt is transferred to dies for meltblowing by use of an extruder and is extruded as fine resin flows. The dies for meltblowing allow introduction of high-speed heated gas. By bringing the heated gas into contact with the resin flows, the resin flows are drafted in a molten state, thereby forming discontinuous fiber fragments having a very small fiber diameter. These discontinuous fiber fragments are collected on a porous support and rolled, to thereby produce a meltblown nonwoven fabric.

When the meltblowing is employed in the present invention, the melting temperature of the resin is 200 to 380° C., particularly preferably 220 to 330° C. When the temperature falls below the above range, melt viscosity increases excessively, leading to difficulty in production of fine resin flows by the mediation of high-speed heated gas. Thus, the produced nonwoven fabric may have a rough texture. When the temperature falls above the above range, melt viscosity of the resin drops considerably, thereby, in some cases, failing to perform spinning with favorable drawing, or reducing the molecular weight of the resin caused by thermal decomposition, leading to deterioration in mechanical properties of the nonwoven fabric, which are disadvantageous.

The heated gas preferably has a temperature at least about 10° C. higher than the melting temperature of the resin; i.e., the temperature is preferably 210 to 390° C., particularly preferably 230 to 340° C. The flow rate of the heated gas is preferably 100 to 600 m/s, particularly preferably 200 to 400 m/s. From the viewpoint of cost, heated air is generally employed as the high-speed, heated gas flow, but a heated inert gas may also be employed so as to prevent deterioration of the resin.

The distance between the meltblowing die and the porous support is a key factor from the viewpoint of dispersibility of single fiber filaments and enhancement of strength of nonwoven fabric based on self-heat-bonding of single fiber filaments. Therefore, the distance is preferably short; i.e., preferably 70 cm or less, more preferably 50 cm or less, particularly preferably 10 to 40 cm.

Particularly when the nonwoven fabric of the present invention is fabricated through the meltblowing, as mentioned above, the (meth)acrylic-based block copolymer serving as a raw material has a number average molecular weight of 8,000 to 700,000, preferably 20,000 to 300,000, more preferably 30,000 to 200,000. In addition, the polymer block A (polymer blocks A1 and A2) content of the (meth)acrylic-based block copolymer employed in the invention is 20 to 45 mass % with respect to the mass of the copolymer, preferably 22 to 40 mass %, more preferably 23 to 37 mass %. By use of such a (meth)acrylic-based block copolymer, a nonwoven fabric exhibiting remarkably excellent light resistance, weather resistance, and flexibility can be produced.

In other words, when the copolymer has a number average molecular weight of less than 8,000, the resin extruded through nozzles cannot maintain the fiber shape and is collected in the form of film on a collection net, the film being strongly (not removable) stuck onto a net. Conventionally, the phenomenon is prevented to some extent by lowering treatment temperature or increasing the distance for collection. In the case of the (meth)acrylic-based block copolymer for forming the nonwoven fabric of the present invention, when the conditions are modified so as to mitigate sticking to such an extent that the resin can be removed from the collection net, the strength of nonwoven fabric is poor, thereby failing to roll up the product.

When the number average molecular weight is in excess of 700,000, so-called shot occurs, thereby providing rough feeling of the fabric (i.e., presence of granular matter on the web). In order to avoid shot, reduction in the amount of primary air or increase in the collection distance is generally effective. In the case of the resin of the present invention, when the approach is employed, web strength decreases considerably, and only a flocculent nonwoven fabric is produced.

In order to improve resistance to sticking to a surface, the nonwoven fabric of the present invention, poly(methyl methacrylate) or a similar substance may be added to the employed resin. So long as the object of the invention can be attained, a variety of additives may be incorporated into the resin, such as an anti-oxidant, a UV-absorber, a photo-stabilizer, a nucleating agent, a neutralizing agent, a lubricant, an anti-blocking agent, a dispersant, a flow-controlling agent, a releasing agent, a pigment, a dye, a filler, and a fire-proofing agent. Among these additives, a UV-absorber or a photo-stabilizer is preferably used, when the nonwoven fabric is used as a product which requires extremely high weather resistance. No particular limitation is imposed on the method for mixing the additives with resin, and chips containing the additive may be blended with resin during spinning, or chips which contain the employed resin and two or more additives and have been produced through melt mixing may be used.

In order to impart higher weather resistance to the nonwoven fabric of the present invention, the UV-absorber content or the photo-stabilizer content is preferably 0.01 to 2.0 mass % based on the mass of the nonwoven fabric, particularly preferably 0.05 to 1.5 mass %.

Examples of the UV-absorber employable in the present invention include UV-absorbers of benzotriazole-based, benzophenone-based, or salicylic ester-based. Of these, UV-absorbers of benzotriazole-based or banzophenone-based are preferred. Examples of the benzotriazole-based UV-absorbers include 2-(2′-hydroxy-3′-t-butyl-5′-methylphenyl)-5-chlorobenzotriazole, 2-(2′-hydroxy-3′,5′-di-t-butylphenyl)benzotriazole, 2-(2′-hydroxy-3′-t-butyl-5′-methylphenyl)benzotriazole, and 2-hydroxy-3-dodecyl-5-methylphenylbenzotriazole. Examples of the benzophenone-based UV-absorbers include 2-hydroxy-4-methoxy-benzophenone, 2-hydroxy-4-n-octoxy-benzophenone, and 4-dodecyloxy-2-hydroxy-benzophenone. These UV-absorbers may be used singly or in combination of two or more species.

Examples of the photo-stabilizer employable in the present invention include hindered amine-based photo-stabilizers. Specific examples include tetrakis(2,2,6,6-tetramethyl-4-piperidyl)-1,2,3,4-butanetetracarboxylate, 4-hydroxy-2,2,6,6-tetramethypiperidine, 4-hydroxy-1,2,2,6,6-pentamethypiperidine, 1-(2-hydroxyethyl)-4-hydroxy-2,2,6,6-tetramethylpiperidine, a condensate of 1-(2-hydroxyethyl)-4-hydroxy-2,2,6,6-tetramethylpiperidine and succinic acid, and a condensate of 1-(2-hydroxyethyl)-4-hydroxy-2,2,6,6-tetramethylpiperidine and adipic acid. These hindered amine-based photo-stabilizers may be used singly or in combination of two or more species.

The mass per unit area (basis weight) of the nonwoven fabric of the present invention produced through the aforementioned method and the average fiber diameter of the fiber for forming the nonwoven fabric may be predetermined in accordance with use thereof. The basis weight is preferably 5 to 150 g/m², particularly preferably 40 to 100 g/m². When the basis weight is less than 5 g/m², production of nonwoven fabric itself is difficult, and uniformity of the nonwoven fabric may be poor. The average fiber diameter is preferably 1 to 30 μm, more preferably 2 to 20 μm, most preferably 3 to 10 μm. When the average fiber diameter is less than 1 μm, flexibility is ensured, but strength decreases, whereas when the diameter is in excess of 30 μm, the nonwoven fabric may provide rough and stiff feeling.

From the viewpoint of ensuring excellent flexibility, the nonwoven fabric of the present invention preferably has a stiffness, as determined through the cantilever method, of 10 to 35 mm, more preferably 10 to 30 mm, most preferably 15 to 25 mm.

By virtue of its excellent light resistance, weather resistance, flexibility, and stretchability, the nonwoven fabric of the present invention can be suitably employed in a variety of applications which require these properties. For example, the nonwoven fabric can be used as an agricultural material such as a thermostat lining sheet of an agricultural greenhouse or a soil-covering sheet for fruit plantation, or as a building material such as a house wrapping sheet. By virtue of its flexibility, the nonwoven fabric can be employed as a textile material or a surface-protective sheet.

Although the nonwoven fabric of the present invention itself exhibits excellent characteristics, the nonwoven fabric may be employed as a composite with a molded article or a sheet material such as film, sheet, paper, woven fabric, or nonwoven fabric. In a composite including at least one layer made of the nonwoven fabric of the present invention, the nonwoven fabric of the present invention may serve as an adhesion layer or an anti-slipping layer, thereby more effectively realizing the characteristics of component layers. No particular limitation is imposed on the form of the composite with other materials, and the composites may be produced through hot-pressing or bonding by the mediation of an adhesive such as a solvent or a binder. Examples of the material which forms a composite with the nonwoven fabric of the present invention include synthetic resins such as polypropylene, polyethylene, polyester, polystyrene, polyamide, polycarbonate, ABS resin, poly(methyl methacrylate), and poly(vinyl chloride); rayon; cotton; and silk. Particularly, a member made of polar resin such as polyurethane, polyester, or polyamide can be laminated with the nonwoven fabric through hot-pressing without use of an adhesive, since the block copolymer employed in the present invention contains a polar monomer. For example, when the nonwoven fabric is laminated with polyurethane nonwoven fabric through hot-pressing, the weather resistance of the polyurethane can be improved without impairing intrinsic stretchability of polyurethane. Polyester-based nonwoven fabric (e.g., poly(ethylene terephthalate) or poly(butylene terephthalate)) is known to have better weather resistance as compared with polyolefin-based nonwoven fabric. When the nonwoven fabric of the present invention is combined with such polyester-based nonwoven fabric, flexibility can be imparted to the polyester without impairing the weather resistance.

### EXAMPLES

The present invention will next be described in more detail by way of examples, which should not be construed as limiting the invention thereto.

In the following Examples and Comparative Examples, physical properties of samples were determined through the following procedures.

(1) Number Average Molecular Weight of Polymers and Block Copolymers

The number average molecular weight of each sample as reduced to polystyrene was determined by use of monodisperse polystyrene as a reference based on a differential refractive index (RI) through gel permeation chromatography (HLC-8020, product of Tosoh Corporation; solvent: tetrahydrofuran).

(2) Proportions of Individual Polymer Blocks in Block Copolymers

The proportions were determined through calculation on the basis of the results of ¹H-NMR analysis.

(3) Fluidity of Block Copolymers

Unless otherwise specified, melt flow rate (MFR) of each sample was determined through a method as stipulated in JIS K-7210 at 190° C. under a load of 21.18 N.

(4) Hardness

Each block copolymer was molded under thermocompression (heating temperature: 200° C., molding pressure: 1.0 MPa), to thereby prepare ten piles (250-mm square sheet with a thickness of 1 mm). A 30-mm square specimen having a thickness of 1 mm was cut from the center of each sheet, and a total ten specimens were stacked (thickness: 1.0 cm). The durometer hardness (type A) of each stacked piece was determined in accordance with a method as stipulated in JIS K-6253.

(5) Mass Per Unit Area (Basis Weight)

A test specimen (200 mm×200 mm) was taken from arbitrary two sites of the target nonwoven fabric sample. The mass of each specimen was measured to the first decimal place, and the measured mass values were averaged and divided by area (m²), to thereby derive the mass per unit area.

(6) Thickness

A test specimen (200 mm×200 mm) was taken from each target nonwoven fabric sample. Thickness of each specimen was measured at arbitrary five points, and the measured thickness values were averaged, to thereby derive the thickness.

(7) Average Fiber Diameter

A photograph of each nonwoven fabric sample was captured under a scanning electron microscope (×1,000). Arbitrary 50 fiber filaments were selected from the photograph, and fiber diameter of each filament was measured and reduced to the magnification. The measured diameters were averaged, to thereby derive the average fiber diameter.

When the diameter of single filament could not be measured due to unclearly images of fiber filaments or entangling of a plurality of filaments, such filaments did not serve as the measurement targets.

(8) Elongation at Break

From each nonwoven fabric sample, test specimens (50×200 mm) were taken in the machine direction and in the cross direction. Each test specimen was subjected to an elongation test in accordance with JIS L-1906 (chuck-to-chuck interval: 50 mm, tensile speed: 300 mm/min). The elongation at break was determined both in the MD and CD directions.

(9) Stiffness

The stiffness was determined in accordance with a method as stipulated in JIS L-1096 (method A; 45° cantilever method). Five test specimens (2.5×15 cm) were taken from each nonwoven fabric sample both in the MD and CD directions. In a cantilever type testing apparatus, each test specimen was placed on a horizontal table having a smooth surface and one slanted (45°) end such that one short side of the specimen was located on a base line of a scale. Subsequently, the specimen was caused to gradually slip along the slant through an appropriate method. When the center of one end of the test specimen was in contact with the slant, the position of the other end of the specimen was measured by the scale. The stiffness is represented by the length (mm) of movement of the specimen. The stiffness was measured both on the front and back sides and both in the MD and CD directions, and these values were averaged (to integer portion). A smaller length means a higher flexibility.

(10) Light Resistance

Each sample was irradiated with UV light for 80 hours by means of a fade meter (UV long-life fade meter FAL-5H•B•BL, product of Suga Test Instruments Co., Ltd., with UV carbon arc lamp, 63° C.). After completion of irradiation, change in color was observed, and tensile strength was determined in accordance with JIS L-1906, before and after irradiation, to thereby derive percent retention of tensile strength. The percent retention was obtained from the following equation:

Percent retention of tensile strength (%)=(G₁/G₀)×100 wherein G₀ represents tensile strength before exposure, and G₁ represents tensile strength after exposure.

(11) Weather Resistance

By use of a Sunshine weatherometer (product of Suga Test Instruments Co., Ltd.), each sample was subjected to a 200-hour exposure test (room temperature of 63° C., humidity of 50%, rainfall 12 min/60 min). The test piece before irradiation and that after irradiation were dissolved in tetrahydrofuran, respectively. The change in molecular distribution index of THF-soluble portion was evaluated in accordance with the method described in (1).

(12) Heat Seal Strength

Polyurethane meltblown nonwoven fabric (abbreviated as PUMB; produced in Comparative Example 1) and polyester spunlaid nonwoven fabric (abbreviated as PESSB; Marix, product of Unitika Ltd.) were provided as test nonwoven fabric samples.

Each nonwoven fabric sample and each of the test nonwoven fabric samples were bonded through sealing at 2 kg/cm² and 120° C. for a pressing time of 1 second.

Each of the thus-prepared test specimens was cut into a piece having a width of 25 mm, and heat seal strength was determined by use of an autograph.

### Example 1

Anionic polymerization was performed in the presence of isobutylbis(2,6-di-t-butyl-4-methylphenoxy)aluminum by use of sec-butyllithium serving as a polymerization initiator. Through the anionic polymerization, methyl methacrylate (hereinafter abbreviated as MMA) serving as a first monomer, n-butyl acrylate (hereinafter abbreviated as nBA) serving as a second monomer, and MMA serving as a third monomer were sequentially polymerized, to thereby yield a block copolymer (polymer block of MMA and that of nBA are abbreviated as PMMA and PnBA, respectively).

The PMMA block produced through polymerization of the first monomer (MMA) was found to have a number average molecular weight of 10,200. The finally produced block copolymer was found to have a number average molecular weight of 110,000 and contain MMA units and nBA units in amounts of 25.0 mass % and 75.0 mass %, respectively. The thus-produced tri-block copolymer has one end portion of a PMMA block and the other end portion of a PMMA block, with a PnBA block being sandwiched by the two end portions. The proportions of three blocks were found to be 12.5 mass %, 12.5 mass %, and 75.0 mass %, respectively. Thus, the tri-block copolymer, represented by PMMA-PnBA-PMMA, was found to have a structure containing a PnBA center block to which one PMMA block was linked at one end and one PMMA block was linked to the other end. The thus-produced tri-block copolymer was found to have an MFR of 1.8 g/10 min and a hardness of 50.

The produced tri-block copolymer was melt-kneaded at 250° C. by use of a melt extruder. The molten polymer flow was fed to a meltblowing die head, and the flow was measured by a gear pump, whereby the polymer melt was extruded through a line of meltblowing nozzles (hole diameter: 0.3 mmφ, pitch: 1.00 mm). Simultaneously, hot air at 260° C. was blown to the extruded polymer, so as to collect extruded fiber on a collection conveyer, thereby producing nonwoven fabric. The following extrusion conditions were employed: throughput; 0.3 g/min/hole, hot air blow; 0.125 Nm³/min/cm-width, and distance between dies and collection conveyer; 30 cm.

The thus-produced nonwoven fabric exhibited no color change after 80-hour irradiation performed by a fade meter, and was found to have a percent retention of tensile strength of 78%. The results are shown in Table 1.

### Example 2

The polymerization procedure of Example 1 was repeated by use of the tri-block copolymer produced through the above method, except that the amounts of monomers were changed. The PMMA block produced through polymerization of the first monomer (MMA) was found to have a number average molecular weight of 6,600. The finally produced block copolymer was found to have a number average molecular weight of 70,000, and have a structure containing a PnBA center block to which one PMMA block was linked at one end and one PMMA block was linked to the other end, with proportions of three blocks being 75.0 mass %, 12.5 mass %, and 12.5 mass %, respectively. Thus, the tri-block copolymer, represented by PMMA-PnBA-PMMA, was found to have an MFR of 81.5 g/10 min and a hardness of 44.

The procedure of Example 1 was repeated, except that the distance between the dies and the collection conveyer was changed to 20 cm, to thereby produce nonwoven fabric. The thus-produced nonwoven fabric exhibited no color change after 80-hour irradiation performed by a fade meter, and was found to have a percent retention of tensile strength of 75%. The results are shown in Table 1.

### Example 3

The polymerization procedure of Example 1 was repeated, except that the amounts of monomers were changed. The PMMA block produced through polymerization of the first monomer (MMA) was found to have a number average molecular weight of 8,300. The finally produced block copolymer was found to have a number average molecular weight of 50,000, and have a structure containing a PnBA center block to which one PMMA block was linked at one end and one PMMA block was linked to the other end, with proportions of three blocks being 65.0 mass %, 17.5 mass %, and 17.5 mass %, respectively. Thus, the tri-block copolymer, represented by PMMA-PnBA-PMMA, was found to have an MFR of 35.2 g/10 min and a hardness of 85.

The procedure of Example 1 was repeated by use of the tri-block copolymer produced through the above method, except that the melt kneading temperature and the distance between the dies and the collection conveyer were changed to 240° C. and 12 cm, to thereby produce nonwoven fabric. The thus-produced nonwoven fabric exhibited no color change after 80-hour irradiation performed by a fade meter, and was found to have a percent retention of tensile strength of 76%. The results are shown in Table 1.

The thus-produced nonwoven fabric was subjected to a heat seal test. The results are shown in Table 2.

### Comparative Example 1

The synthesis of PMMA-PnBA-PMMA tri-block copolymer of Example 1 was repeated, except that a portion of polymerization reaction mixture was collected before performing of the third polymerization, to thereby obtain a PMMA-PnBA di-block copolymer. The PMMA block produced through polymerization of the first monomer (MMA) was found to have a number average molecular weight of 10,200. The finally produced block copolymer was found to have a number average molecular weight of 91,500 and have a PMMA block content in the di-block copolymer of 14.1 mass %. The di-block copolymer was meltblown so as to form nonwoven fabric. However, the produced nonwoven fabric exhibited strong stickiness among fiber filaments and poor handling properties. The results are shown in Table 1.

### Comparative Example 2

Polyurethane resin (hardness 95) was dried to a water content of 200 ppm or less. The dried polyurethane resin was melt-kneaded at 250° C. by use of a melt extruder. The molten polymer flow was fed to a meltblowing die head, and the flow was measured by a gear pump, whereby the polymer melt was extruded through a line of meltblowing nozzles (hole diameter: 0.3 mmφ, pitch: 1.00 mm). Simultaneously, hot air at 260° C. was blown to the extruded polymer, so as to collect fiber on a collection conveyer, thereby producing nonwoven fabric. The following extrusion conditions were employed: throughput; 0.3 g/min/hole, hot air blow; 0.125 Nm³/min/cm-width, and distance between dies and collection conveyer; 20 cm. The thus-produced nonwoven fabric exhibited apparent yellowing after 80-hour irradiation performed by a fade meter, and was found to have a percent retention of tensile strength of 43%. The results are shown in Table 1.

### Comparative Example 3

Styrene-ethylene/propylene-styrene tri-block copolymer (styrene content: 30 mass %, hardness: 80, and MFR: 70 g/10 min) (60 mass %) and separately provided polypropylene resin (MFR: 300 g/10 min, in accordance with ASTM D1238) (40 mass %) were mixed through chip blending, and the mixture was molten at 310° C. by means of a melt-extruder. The temperature of hot air was changed to 310° C. Other procedures employed in Comparative Example 2 were repeated, to thereby produce nonwoven fabric. The thus-produced nonwoven fabric exhibited no change in color after 80-hour irradiation performed by a fade meter, but was found to have a percent retention of tensile strength of 60%. The results are shown in Table 1.

The thus-produced nonwoven fabric was subjected to a heat seal test. The results are shown in Table 2.

TABLE 1

| | Mass | | Av. | | | Percent |
|---|---|---|---|---|---|---|
| | per | | fiber | Elongation | | retention |
| | Unit | Thick- | diame- | at break | | of light |
| | area | ness | ter | MD × CD | Stiffness | resistance |
| | (g/m²) | (mm) | (μm) | (%) | (mm) | (%) |
| Ex. 1 | 75.2 | 0.332 | 11.1 | 286 × 321 | 15 | 78 |
| Ex. 2 | 71.6 | 0.170 | 4.8 | 326 × 211 | 16 | 75 |
| Ex. 3 | 51.3 | 0.247 | 6.3 | 84 × 178 | 21 | 76 |
| Comp. | Production of nonwoven fabric impossible | | | | | |
| Ex. 1 | | | | | | |
| Comp. | 70.5 | 0.244 | 7.1 | 326 × 319 | 39 | 43 |
| Ex. 2 | | | | | | |
| Comp. | 70.1 | 0.358 | 6.6 | 379 × 393 | 68 | 60 |
| Ex. 3 | | | | | | |

TABLE 2

Heat seal test

| | PUMB (N/25 mm) | PESSB (N/25 mm) |
|---|---|---|
| Ex. 3 | 7.1 | 10.5 |
| Comp. Ex. 3 | 0.1 | 0.1 |

### Example 4

The procedure of Example 3 was repeated, except that the following additives were added, during melt kneading, to the tri-block copolymer produced in Example 3, to thereby produce a nonwoven fabric.

UV absorber: 2-(2′-hydroxy-3′-t-butyl-5′-methylphenyl)-5-chlorobenzotriazole (ADK STAB LA-36, product of Asahi Denka Co., Ltd.) (0.2 mass %);
Photo-stabilizer: tetrakis(2,2,6,6-tetramethyl-4-piperidyl)-1,2,3,4-butanetetracarboxylate (ADK STAB LA-57, product of Asahi Denka Co., Ltd.) (0.2 mass %); and
Anti-oxidant: bis(2,6,-di-t-butyl-4-methylphenyl)pentaerythritol diphosphite (ADK STAB PEP-36, product of Asahi Denka Co., Ltd.) (0.05 mass %) and tetrakis[methylene-3-(3,5-di-t-butyl-4-hydroxyphenyl)propionato]methane (ADK STAB A0-60, product of Asahi Denka Co., Ltd.) (0.05 mass %).

The thus-produced nonwoven fabric was dissolved in tetrahydrofuran, and the molecular weight distribution factor (Mw/Mn) was determined to be 1.1. After completion of a 200-hour exposure test by means of a Sunshine weatherometer, the molecular weight distribution factor (Mw/Mn) was found to be 2.1.

### Comparative Example 4

The procedure of Comparative Example 3 was repeated, except that the following additives were added, during melt kneading, to the tri-block copolymer produced in Comparative Example 3, to thereby produce a nonwoven fabric.

UV absorber: 2,2+-methylenebis[4-(1,1,3,3-tetramethylbutyl)-6-(2H-benzotriazol-2-yl)phenol] (ADK STAB LA-31, product of Asahi Denka Co., Ltd.) (1.0 mass %);
Photo-stabilizer: poly[{6-(1,1,3,3-tetramethylbutyl)amino-1,3,5-triazine-2,4-diyl}{(2,2,6,6-tetramethyl-4-piperidyl)imino}hexamethylene{(2,2,6,6-tetramethyl-4-piperidyl)imino}] (Chimassorb 944, product of Ciba Specialty Chemicals K. K.) (0.5 mass %) and 4-hydroxy-2,2,6,6-tetramethyl-1-piperidineethanol/dimethylsuccinate polymer (Tinuvin 622, product of Ciba Specialty Chemicals K. K.) (0.5 mass %); and
Anti-oxidant: tetrakis[methylene-3-(3,5-di-t-butyl-4-hydroxyphenyl)propionato]methane (ADK STAB A0-60, product of Asahi Denka Co., Ltd.) (0.5 mass %).

The thus-produced nonwoven fabric was dissolved in tetrahydrofuran, and the molecular weight distribution factor (Mw/Mn) was determined to be 1.0. After completion of a 200-hour exposure test by means of a Sunshine weatherometer, the molecular weight distribution factor (Mw/Mn) was found to be 1.6.

### Comparative Example 5

The nonwoven fabric produced in Comparative Example 3 was subjected to a 200-hour exposure test by means of a Sunshine weatherometer. The test results revealed that cross-linking in the nonwoven fabric proceeded due to deterioration, and the deteriorated nonwoven fabric was not dissolved in a solvent, leading to formation of gel.

As is clear from the results, the block copolymer for forming the nonwoven fabric of Example 4 has excellent weather resistance. Thus, the amount of a weather resistance-improving additive required for attaining a predetermined level of weather resistance is only ⅕, as compared with the case of the styrenic elastomer for forming the nonwoven fabric of Comparative Example 4. The nonwoven fabric of Comparative Example 5 exhibited poor weather resistance, and gelation of the component polymers occurred.

### INDUSTRIAL APPLICABILITY

The nonwoven fabric of the present invention has excellent light resistance, weather resistance, flexibility, and stretchability, and therefore, can be suitably used in a variety of applications requiring these properties, such as agricultural materials.

1. A nonwoven fabric comprising fiber primarily formed of a (meth) acrylic-based block copolymer, wherein the (meth)acrylic-based block copolymer satisfies the following (a) to (c):
(a) the (meth)acrylic-based block copolymer has a structure represented by the following formula (I):
A1-B-A2 (I)
wherein A1 and A2, which may be identical to or different from each other, each represent a polymer block formed from a methacrylic ester, an acrylic ester, or an aromatic Vinyl compound; B represents a polymer block formed from a methacrylic ester or an acrylic ester; and B is immiscible with A1 and A2 and has a glass transition temperature of 20° C. or lower;
(b) the (meth)acrylic-based block copolymer has a number average molecular weight of 8,000 to 700,000; and
(c) the (meth)acrylic-based block copolymer has a total polymer block A content of 20 to 45 mass % based on the entire mass of the block copolymer.

2. The nonwoven fabric as claimed in claim 1, wherein both of the polymer blocks A1 and A2 of the (meth)acrylic-based block copolymer are formed from a methacrylic ester, at least one of the polymer blocks A1 and A2 has a glass transition temperature higher than 25° C., and the polymer block B is formed from an acrylic ester.

3. The nonwoven fabric as claimed in claim 1, which is composed of fiber having an average fiber diameter of 1 to 30 μm.

4. The nonwoven fabric as claimed in claim 1, which is a meltblown nonwoven fabric.

5. The nonwoven fabric as claimed in claim 1, which has a mass per unit area of 5 to 150 g/m².

6. The nonwoven fabric as claimed in claim 1, which contains a benzotriazole-based UV absorber or a benzophenone-based UV absorber, in an amount of 0.01 to 2.0 mass %.

7. The nonwoven fabric as claimed in claim 1, which contains a hindered amine-based photo-stabilizer in an amount of 0.01 to 2.0 mass %.

8. A composite product, comprising at least one layer composed of a nonwoven fabric of claim 1.
